(19) United States
(12) Patent Application Publication
(10) Pub. No.: US 2024/0054831 A1
(43) Pub. Date: Feb. 15, 2024

(54) ELECTRONIC SECURITY SYSTEM

(71) Applicant: Miroslav Tyrpa, Ostrava (CZ)

(72) Inventor: Miroslav Tyrpa, Ostrava (CZ)

(21) Appl. No.: 18/257,708

(22) PCT Filed: Dec. 15, 2021
(86) PCT No.: PCT/CZ2021/050151

§ 371 Date: Jun. 15, 2023

(30) Foreign Application Priority Data
Jan. 18, 2021 (CZ) PV 2021-18

(51) Int. Cl. G07C 9/00; G07C 9/21

(52) U.S. Cl. CPC G07C 9/00817; G07C 9/21; G07C 2009/00761

(57) ABSTRACT

An electronic security system, comprising a portable electronic controller (1) equipped with an internal memory (2) to store a one-time control code (3), and respectively an identifier (10) and/or a blocking code (11) as well, and a structurally separated at least one electronic release unit (4), which is however functionally connected to it, the electronic release unit (4) comprises a central memory (5) provided to store the set (8) of the backup one-time control codes, and respective the identifier (10) as well, an actuator (7) and a control processor (6), which is communicatively connected to the central memory (5) of the electronic release unit (4), to the internal memory (2) of the portable electronic controller (1), and to the actuator (7). The actuator (7) is put into operation if, in the set (8) of the backup one-time control codes, there is a still unused backup one-time control code (3′) identical to the one-time control code (3) stored in the internal memory (2) of the portable electronic controller (1). The system is especially provided for objects and facilities with the requirement for a maximum degree of security.

### TECHNICAL FIELD

The invention relates to an electronic security system provided for locking and unlocking especially locks of objects with the requirement for a maximum degree of security, the electronic security system comprises at least one portable electronic controller with an internal memory to store a one-time control code, and at least one electronic release unit with a central memory to store a of backup one-off control codes, with a control processor, and with a locking and unlocking actuator, respectively.

### PRIOR ART

The patent document DE102011103134 (A1) discloses a method of generating a one-time release code to bring an electronic lock from the locked position to the unlocked position. The principle of this method is that immediately after the use of the release code stored in the memory of the electronic lock to unlock the lock, a new usable release code is generated by its encryption with the use of an encrypting algorithm and with the application of an encrypting key, the new release code will occupy the position of the old release code in the memory of the electronic key while it must also be stored in the memory of the lock and will be used for the next unlocking of the lock. Thanks to the fact that a new release code is available for every unlocking of the lock, this lock achieves a high security level. However, its disadvantage is a relatively high structural complexity, wherein an encrypting algorithm and an encrypting key is necessary to generate a new release code. Another disadvantage is that in case of loss or theft of the electronic key, it might be used or misused by an unauthorized person. This system might also be misused if an unauthorized person succeeds in revealing the encryption algorithm of the newly generated release codes. Although the subject matter of this invention is a method for generating a release code, it is obvious that to use it, each lock must have its own key, i.e. it cannot be used if multiple keys are necessary for one key or if one key should be used to control multiple locks.

### DISCLOSURE OF INVENTION

The subject matter of the invention is an electronic security system, powered by electricity from the mains and/or from an autonomous power supply, and provided for locking and unlocking especially locks of the objects, the electronic security system comprises at least one portable electronic controller with an internal memory to store a one-time control code, and at least one separately from the portable electronic controller arranged an electronic release unit with a central memory, a control processor for functional communication of the internal memory of the portable electronic controller, with the central memory of the electronic release unit, and with an actuator of this system as well. The matter of the invention lies in the fact, that in the central memory of each electronic release unit, a set of backup one-time control codes is stored, the set of the backup one-time control codes is exclusively assigned to one particular portable electronic controller, and its control processor is programmed to pair the one-time control code with the backup one-time control code in the set of the backup one-time control codes to subsequently put the actuator into operation in the case, if in the set of backup one-time codes, there is a still unused backup one-time control code identical to the one-time control code stored in the internal memory of the portable electronic controller, and to replace the used one-time control code in the internal memory of the portable electronic controller with a copy of the next following backup one-time control code from their set stored in the central memory of the electronic release unit. The control processor of this system is connected in a wired manner or wirelessly both to the central memory of the electronic release unit and to the actuator, and to the internal memory of the portable electronic controller as well. The control processor wired (contact) connection to this internal memory is implementable by means of an activation contact of the electronic release unit and a connection contact of the portable electronic controller.

If the electronic security system comprises a large number of the electronic release units controllable by one portable electronic controller, an identical set of the backup one-time control codes assigned to this portable electronic controller is always stored in their central memories. The control processors of these electronic release units are programmed to put their actuators into operation, if in the set of the backup one-time control codes of the electronic release unit contacted by the portable electronic control, there is still unused backup one-time control code identical to the one-time control code stored in the internal memory of the portable electronic controller, and to replace the used one-time control code in the internal memory of the portable electronic controller with a copy of the next following backup one-time control code from the set of the backup one-time codes stored in the central memory of the contacted electronic release unit.

In another case, when two and more portable electronic controllers are intended to control one or more electronic release units, the central memories of these electronic release units are divided into memory segments in the number equal to the number of the portable electronic controllers provided to control them. One of the memory segments of the relevant electronic release unit is assigned to each of these portable electronic controllers, a unique set of the backup one-time control codes that is assigned exclusively to the said one portable electronic controller being stored in the said memory segment. The control processor is programmed to put the actuator into operation if in this particular memory segment of this particular electronic release unit, there is a still unused backup one-time control code identical to the one-time control code stored in the internal memory of the used portable electronic controller, and to replace the just used one-time control code in the internal memory of this portable electronic controller with a copy of the next following backup one-time control code from the set stored in the used memory segment of the contacted release unit.

The above-mentioned structural arrangements of the electronic security assemblies as wholes and the electronic release units as their physically separated parts make possible to create relatively simple and cost-efficient, but especially very effective and safe security devices. The one-time usability of the control code stored in the internal memory of the portable electronic controller and the one-time usability of the control code that is replaced with a copy of a so far unused backup one-time control code from the set of these codes stored in the central memory of the relevant electronic release unit, or in its relevant memory segment, running independently of the human factor, ensure perfect protection of the one-time control code from being copied or misused in another way, as the copy of the backup one-time control code that replaces it is not generated from this just used one-time control code, and therefore it is not dependent on it in any way, and therefore it is not traceable, decodable or calculable in any manner either. From the practical point of view, one of significant benefits of the electronic security system according to the present invention is that it also makes possible to control more electronic release units with one portable electronic controller, or conversely, to assign the multiple portable electronic controllers to one electronic release unit for its multiple users. However, benefits of the electronic security system according to the present invention especially comprise that it makes possible to assign the multiple portable electronic controllers with the same as well as different access options to the multiple electronic release units.

An additional improvement of the security level of the electronic security system according to the present invention is achieved by the fact that the internal memory of the portable electronic controller comprises the own identifier, whose identification data exclusively belong to this portable electronic controller, wherein these identification data are stored in the central memory of the electronic release unit at the same time, where a unique set of backup one-time control codes, also exclusively belonging to this portable electronic controller, is stored separately from the identification data. The control processor of the electronic security system conceived in this way is, besides putting the actuator into operation and replacing the used one-time control code with a copy of a backup one-time control code, also programmed to initially verify the authorization of the used portable electronic controller for communication with the electronic release unit based on the verification of the consistency of the identification data of the identifier stored in the internal memory of the portable electronic controller and in the central memory of the electronic release unit. In the case of multiple release units that are controlled by one portable electronic controller, the data of its identifier are stored in the central memory of each of these electronic release units. In the case of multiple portable electronic controllers intended to control one or more electronic release units, the central memories of these electronic release units are divided into segments in numbers corresponding to the numbers of the portable electronic controllers provided to control them. The identification data of the identifiers of the particular portable electronic controllers are then stored in the memory segments, assigned to them, of the relevant electronic release unit, or relevant electronic control units, if there are more of them, separately from the unique sets of the backup one-time control codes, which are also stored in them.

To avoid using the portable electronic controller by an unauthorized person due to its theft or loss, which are the most significant and practically the only security risks of the electronic security system according to the present invention, the internal memory of the portable electronic controller can be equipped with a blocking code, without the unblocking of which by means of the entry of the blocking code in an unblocker, the portable electronic controller will not be able to establish communication with the electronic release unit, as a result of which its actuator cannot be actuated. The unblocker of this blocking code can then be installed in the manual part of the portable electronic controller. The blocking code of the portable electronic controller may preferably be a PIN code, its unblocker being a keypad adapted for entering this PIN code. The introduction of this additional security element makes the electronic security system according to this invention practically unbeatable, even in case of a loss or theft of the portable electronic controller.

A significant advantage of the electronic security system according to this invention is also that the unique set of mutually different backup one-time control codes may comprise a set of alphanumeric codes composed of any number of any characters that can be registered in an electronic memory, in this case the central memory of the electronic release unit, or subsequently also in the internal memory of the portable electronic controller. Thus, the composition of the control codes does not need to be limited to the characters of a binary or another numeric system only, but besides the numeric characters, it may also use the characters of all existing alphabets, punctuation marks or other characters that can be written in an electronic memory. This provides the possibility of creating a practically unlimited number of combinations of various characters, and therefore a set of backup one-time control codes of a nearly unlimited size.

On every attempt of putting the actuator into operation, the electronic security system according to this invention is characterized by individual steps realized especially on the basis of the corresponding programming of the control processor.

In the case of the electronic security system comprising one portable electronic controller for one or more electronic release units, the steps are as follows:
activating the electronic security system by establishing communication between the portable electronic controller and the electronic release unit through their contact or contactless connection.
determining whether in the set of the backup one-time control codes, stored in the central memory of the electronic release unit, or in the central memories of the contacted electronic release units, in the case of multiple units, there is a still unused backup one-time control code that is identical to the one-time control code stored in the internal memory of the portable electronic controller. In the case of a contact method of communication between the portable electronic controller and the electronic release unit, this determination is realised by means of the control processor, i.e. by a direct path of an electric signal provided through a connection contact and an activation contact. In the case of a contactless method of communication between the portable electronic controller and the electronic release units, this determination is enabled by the conversion of a radio, optical or acoustic signal, which is used to send the one-time control code from the portable electronic controller to the contacted electronic release unit, to an electric signal.
if in the previous step, the match is found between the one-time control code of the used portable electronic controller and a still unused backup one-time control code in the set of these codes, stored in the central memory of the contacted electronic release unit, a command for the actuator to carry out a pre-determined operation is issued through the control processor. The positive result of the pairing, causing the activation of the actuator, becomes the particular one-time code an already used one, this code cannot be used any more. Activation of the actuator will lead to releasing the electronic security system, e.g. unlocking a lock of the object.
At the same time, a command is issued by the control processor to replace the just used one-time control code in the internal memory of the portable electronic controller with a copy of the next following backup one-time control code from the set of these codes stored in the central memory of the contacted electronic release unit. This copy of the backup one-time control code from their set, which is located in the central memory of the contacted electronic release unit, becomes, by being stored in the internal memory of the portable electronic controller, its new one-time control code, i.e. the code which can only be used once, and the set of backup one-time control codes in the central memory of the electronic release unit represents some stack of these control codes that can only be used once.

In the case of the electronic release unit controllable by multiple portable electronic controllers and the corresponding division of the central memory of the electronic release unit, or the central memories of the electronic release units, if there are multiple electronic release units, into memory segments, this process proceeds in the same steps in the memory segment, in whose set of backup one-time control was found a still unused backup one-time control code identical to a one-time control code stored in the internal memory of the used portable electronic controller.

### BRIEF DESCRIPTION OF DRAWINGS

The invention is further clarified in more detail with reference to drawings where:

FIG. 1—shows a diagram of the system according to the invention in an exemplary embodiment comprising one portable electronic controller and three electronic release units;

FIG. 2—shows a diagram of the system according to the invention in an exemplary embodiment comprising four portable electronic controllers and one electronic release unit;

FIG. 3—shows a diagram of the system according to the invention representing a portable electronic controller equipped with a blocking code and a keypad for its unblocking.

### DESCRIPTION OF PREFERRED EMBODIMENTS

### Embodiment 1

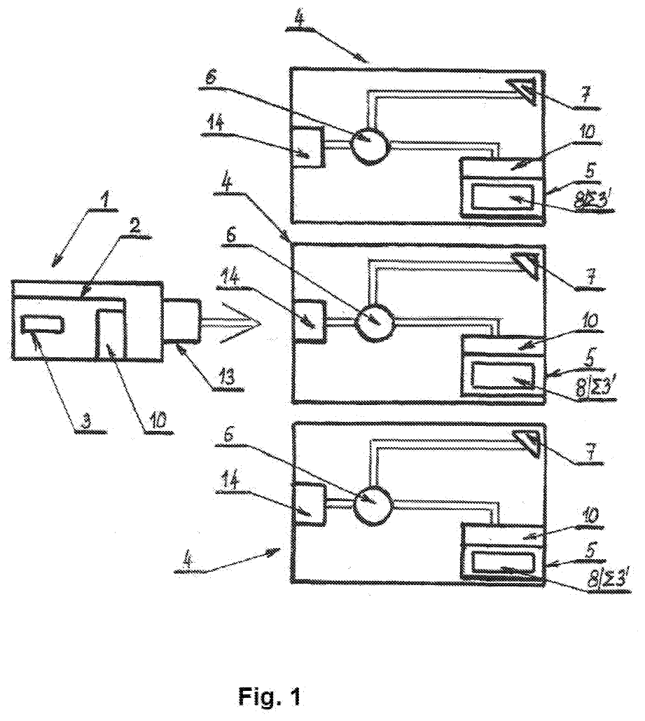

The electronic security system according to the exemplary embodiment, which is schematically shown in FIG. 1, it comprises one portable electronic controller 1 and three electronic release units 4. It is the electronic security assembly for locking (and of course also unlocking) of three objects, e.g. an apartment, office and garage, owned by one person. The portable electronic controller 1 comprises an external flash disk with the internal memory 2, in which a one-time control code 3 is stored, and whose data concerning the size, serial number and production date, stored in its boot track, represent at the same time the identifier 10 of this portable electronic controller 1. Particular electronic release units 4 are equipped with the central memories 5, wherein in each of them, the data of the identifier 10 of the portable electronic controller 1 and an identical set 8 of the backup one-time control codes assigned only to it, are stored separately from each other. These electronic release units are further equipped with the actuators 7 and identically programmed control processors 6. Each of the control processors 6 is programmed to put into operation the actuator 7 assigned to it, if the match is found between the data of the identifier 10 stored in the internal memory 2 of the portable electronic controller 1 and in the central memory 5 of the relevant electronic release unit 4, and if in the set 8 of the backup one-time control codes located in the central memory 5 of the contacted electronic release unit 4, there is located, at the same time, a still unused backup one-time control code 3′ identical to the one-time control code 3 stored in the internal memory 2 of the portable electronic controller 1. Each of the control processors 6 is also programmed to replace the just used one-time control code 3 in the internal memory 2 of the portable electronic controller 1 with a copy of the next following one-time control code 3′ from the set 8 of the backup one-time control codes stored in the central memory 5 of the contacted electronic release unit 4 in the event that its relevant actuator 7 is put into operation. The portable electronic controller 1 is equipped with the connection contact 13, and each electronic control unit 4 is equipped with the activation contact 14. The activation contacts 14 of all electronic release units 4 are structurally adapted for mutual mechanical connection to the connection contact 13 of the portable electronic controller 1 (USB contacts), which enables a direct (contact) communication connection between the portable electronic controller 1 and individual electronic release units 4, the control processors 6 of which are connected in a wired manner to both the central memories 5, and the actuators 7. The electronic release units 4 are powered with electricity from the mains (not shown in the figure).

When operating of the electronic security system in this embodiment, the connection contact 13 of the portable electronic controller 1 is firstly plugged into the activation contact 14 of one of the electronic control units 4 depending on which of the objects needs to be unlocked. This operation above will close the communication circuit and an electronic communication is established between the control processor 6 of the relevant electronic release unit 4, its central memory 5 and the internal memory 2 of the portable electronic controller 1. By means of the relevant control processor 6, firstly it is found out whether the data of the identifier 10 contained in the internal memory 2 of the portable electronic controller 1 are identical to its data stored in the central memory 5 of the contacted electronic control unit 4. This operation will verify whether it is an authorized use of the portable electronic controller 1. If they are found to match, the relevant control processor 6 is further used to verify whether the one-time control code 3 stored in the internal memory 2 of the portable electronic controller 1 is identical to a still unused backup one-time control code 3′ contained in the set 8 of backup one-time control codes stored in the central memory 5 of the contacted electronic release unit 4. If such a still unused backup one-time control code 3′ is found in their relevant set 8, the control processor 6 will send a signal to the actuator 7 controlled by it, which will subsequently carry out a pre-determined release action. At the same time, by means of the relevant control processor 6 it is selected from the relevant set 8 of the backup one-time control codes, stored in the central memory 5 of the contacted electronic release unit 4, the next following backup one-time control code 3′, and its copy is used to replace the just used one-time control code 3 in the internal memory 2 of the portable electronic controller 1. Here, this copy of the backup one-time control code 3′ becomes the new one-time control code 3 ready for a subsequent one-time use. By means of the relevant control processor 6 a record of the use is made for the just used backup one-time control code 3′ in the central memory 5 of the relevant electronic release unit 4. This backup one-time control code 3′ that has been used once cannot be used to replace the one-time control code 3 for the second time in spite of the fact that it was not used in the central memories 5 of the remaining electronic release units 4, and it remains in them without a record of such a use. For further operation of this electronic security system, this backup one-time control code 3′ remains longer unusable in the central memories 5 of their remaining electronic release units 4.

### Embodiment 2

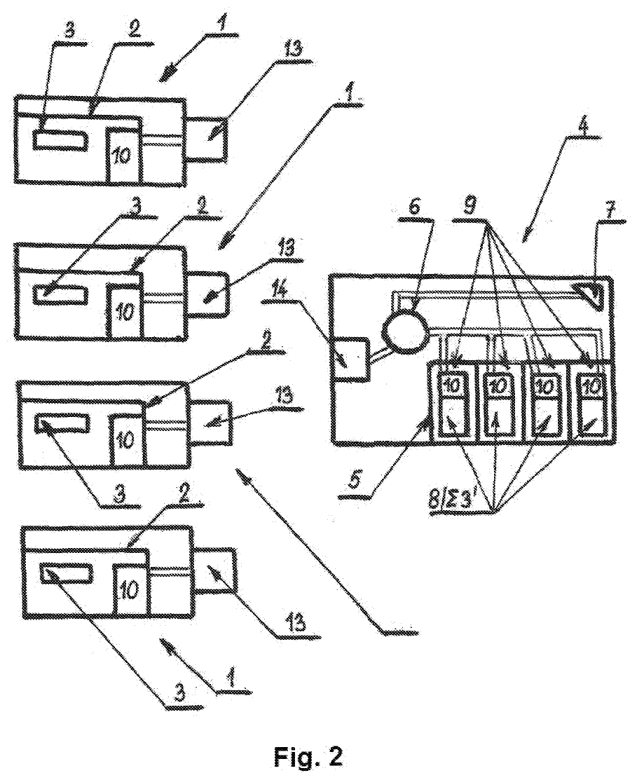

The electronic security system according to the exemplary embodiment, which is schematically shown in FIG. 2, it comprises four portable electronic controllers 1 and one electronic release unit 4 controllable by them. It makes it possible to control one electronic release unit 4, e.g. a door lock, with four portable electronic controllers 1. The portable electronic controllers 1 have the form of external flash disks equipped with connection contacts 13 provided as USB contacts. They are equipped with internal memories 2 in which the one-time control codes 3 that have been assigned to them are stored, and whose data of size, production number and production date recorded in their boot tracks at the same time represent the identifiers 10 of these portable electronic controllers 1. The electronic release unit 4 is equipped with an activation contact 14, also having the form of a USB contact adapted to be connected to the connection contacts 13 of all four portable electronic controllers 1. It is further equipped with a central memory 5 that is divided into four memory segments 9, each of which is provided for one of the portable electronic controllers 1. In these memory segments 9, the data of the identifiers 10 of the assigned portable electronic controllers 1 are stored, and separately from them, also the relevant sets 8 of backup one-time control codes. The electronic release unit 4 further comprises the actuator 7 and the control processor 6 that is connected in a wired manner to both the central memory 5, and the actuator 7, and via the activation contact 14 of the electronic release unit 4 and the connection contacts 13 of the portable electronic controllers 1 to their internal memories 2 as well. The control processor 6 is programmed to only activate the electronic security system in case, that in one of their memory segments 9, the data of the identifier 10 belonging to the used portable electronic controller 1 are stored. The control processor 6 is further programmed to subsequently determine whether in the memory segment 9 identified this way, there is also a still unused backup one-time control code 3′ identical to the one-time control code 3 stored in the internal memory 2 of this currently used portable electronic controller 1. In case of such a match, it will put the actuator 7 into operation. At the same time, the control processor 6 is programmed to replace the just used one-time control code 3 in the internal memory 2 of the used portable electronic controller 1 with the next following backup one-time control code 3′ from the relevant set 8 of the backup one-time control codes stored in the contacted memory segment 9. The electronic release unit 4 is powered with electricity from the mains (not shown in the figure).

When operating the electronic security system in this embodiment, the connection contact 13 of one of the portable electronic controllers 1 is plugged into the activation contact 14 of the electronic release unit 4. This will close the communication circuit and communication is established between the control processor 6 and the relevant internal memory 2 of the used portable electronic controller 1, and at the same time the memory segments 9 of the central memory 5 of the electronic release unit 4 as well. By means of the control processor 6 it is first found out whether the identification data of the identifier 10 contained in the internal memory 2 of the used portable electronic controller 1 are stored in one of the memory segments 9 at the same time. If it is not the case, communication will be terminated. If it is the case, it will further check whether in the set 8 of the backup one-time control codes stored in the memory segment 9 identified this way there is also a still unused backup one-time control code 3′ identical to the one-time control code 3 of the used portable electronic controller 1. If it is not the case, communication will be terminated. If the result of this check is positive as well, the control processor 6 will send a command to the actuator 7, which will execute the action it has been provided for. At the same time, the next following backup one-time control code 3′ is copied from the set 8 stored in the contacted memory segment 9, and this copy of the code is used to replace the just used one-time control code 3 in the internal memory 2 of the used portable electronic controller 1. A record of the use of the just used backup one-time control code 3′ will be made by the control processor 6 in the relevant memory segment 9 of the electronic release unit 4.

### Embodiment 3

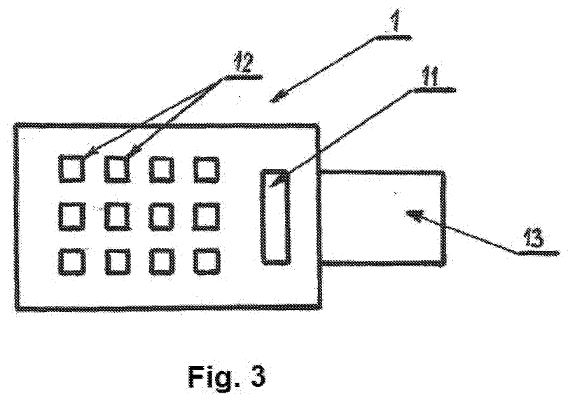

Another preferred embodiment of the electronic security system according to this invention consists in that it uses the portable electronic controllers 1 as shown in FIG. 3, the internal memories 2 of which are equipped with the blocking codes 11, advantageously in the form of PIN codes, the unblocker 12 in the form of a keypad adapted to enter this blocking code 11 and arranged preferentially on an outer side of the portable electronic controller 1 is being used for their unblocking. The unblocking of the blocking code 11, which is performed before every use of the portable electronic controller 1 in such a way that the user, who is the only one to know it, enters it in the unblocker 12, protects the portable electronic controllers 1 from being misused even in case of their loss or theft. Thus, in this embodiment, the electronic security system achieves the maximum security level. The blocking code 11 may also be a part of the identifier 10 of the portable electronic controller 1.

### INDUSTRIAL APPLICABILITY

The electronic security system according to this invention has very wide range of uses. Starting from conventional mechanical or electromechanical locks of building and room doors, through locking mechanisms of safes and bank treasuries, military and other strictly guarded objects, to the access to bank accounts. It can be used everywhere where something should be protected from the access of unauthorized persons. It can also be used to introduce a system of identification of persons, which might replace even the latest versions of personal identity cards or similar identity documents in a more advanced manner.

### LIST OF REFERENCE SIGNS

1 portable electronic controller
2 internal memory
3 one-time control code
3′ backup one-time control code
4 electronic release unit
5 central memory
6 control processor
7 actuator
8 set of backup one-time control codes
9 memory segment
10 identifier (of the portable electronic controller)
11 blocking code
12 unblocker
13 connection contact
14 activation contact

1. An electronic security system, powered by electricity from mains and/or from an autonomous power supply, and provided for locking and unlocking especially locks of objects, the electronic security system comprises at least one portable electronic controller with an internal memory to store a one-time control code, and at least one separately from the portable electronic controller arranged an electronic release unit with a central memory, a control processor and an actuator of this system, characterized in that a unique set of backup one-time control codes assigned to each portable electronic controller provided to control the relevant electronic release unit is stored in the central memory of each electronic release unit, and its control processor is programmed to pair the one-time control code with a backup one-time control code in the set of the backup one-time control codes by searching through sets of the backup one-time control codes, to put subsequently the actuator into operation, to replace the used one-time control code in the internal memory of the portable electronic controller with a copy of the next following backup one-time control code from the set of the backup one-time control codes, and to made a record of the use for the just used backup one-time control code in the central memory of the relevant electronic release unit to prevent the once used backup one-time control code) from being used a second time, wherein the control processor is communicatively connected to both the central memory and to the actuator and to the internal memory as well, whose contact connection with the control processor is realisable by means of an activation contact of the electronic release unit, and of a connection contact of the portable electronic controller.

2. The electronic security system according to claim 1, characterized in that in the case of two and more electronic release units controlled by one portable electronic controller, an identical set of the backup one-time control codes is always stored in their central memories.

3. The electronic security system according to claim 1, characterized in that in the case of two and more portable electronic controllers provided to control at least one electronic release unit, the central memory of each of them is divided into memory segments in a number equal to the number of the portable electronic controllers provided to control the electronic release unit, wherein one of the memory segments of this electronic release unit is assigned to each of these portable electronic controllers, and in this memory segment a unique set of the backup one-time control codes exclusively assigned to this one portable electronic controller is stored.

4. The electronic security system according to claim 1, characterized in that the internal memory of each portable electronic controller further comprises an own identifier, the identification data of which that exclusively belongs to the particular portable electronic controller, are, separately from the set of the backup one-time control codes, also stored in the central memory of the electronic release unit, and its control processor is programmed to initially pair the data of this identifier with the data stored in the central memory, wherein in the case of two and more electronic release units controlled by the same portable electronic controller, the data of the identifier are stored in the central memories of all the electronic release units, and in the case of two and more portable electronic controllers provided to control at least one electronic release unit, the data of the identifiers of particular portable electronic controllers are also stored in to them assigned memory segments of the relevant electronic release unit.

5. The electronic security system according to claim 1, characterized in that the portable electronic controllers are equipped with a blocking code and its unblocker.

6. The electronic security system according to claim 1, characterized in that each of the unique sets of the backup one-time control codes stored in the central memory of the electronic release unit, or in its particular memory segments, comprises a plurality of the backup one-time control codes composed of any number of any combined numeric, alphabetic, punctuation, and respectively other characters capable of being registered in an electronic memory.
